(19) United States
(12) Patent Application Publication
(10) Pub. No.: US 2007/0218378 A1
(43) Pub. Date: Sep. 20, 2007

(54) THERMALLY PRINTABLE ELECTRICALLY CONDUCTIVE RIBBON AND METHOD

(75) Inventors: Stephen F. Drews, Williamsburg, MI (US); Richard A. Padilla, Queen Creek, AZ (US)

Correspondence Address: Levenfeld Pearlstein, LLC (ILLINOIS TOOL WORKS), 2 North LaSalle Street, Suite 1300, CHICAGO, IL, 60602, US

(73) Assignee: ILLINOIS TOOL WORKS, INC., Glenview, IL (US)

(21) Appl. No.: 11/308,299

(22) Filed: Mar. 15, 2006

(51) Int. Cl. G03G 15/02

(52) U.S. Cl. 430/58.8

(57) ABSTRACT

A thermally transferable electrically conductive ribbon includes a carrier web having first and second sides and an electrically conductive layer disposed on the first side of the carrier web. A portion of the electrically conductive layer is transferable to an associated object to form an electrically conductive circuit thereon. A method for making and using the ribbon are also disclosed.

### BACKGROUND OF THE INVENTION

The present invention is directed to a transferable conductive ribbon and a method of making a conductive pathway. More particularly, the present invention is directed to a conductive ribbon that is thermally applied or printed to a substrate.

There are many known processes for fabricating circuitry. One such process that is particularly useful in the fabrication of flexible or bendable circuitry is a silkscreen method. Such circuitry is found in, for example, automobile dashboards, appliance control panels, aircraft backlit panels, computers and the like. The circuitry is printed on to a flexible substrate such as a polyester film.

The silkscreen process, however, can be quite complex. First, a screen is fabricated to meet the particular, desired circuit by producing a photographic negative of the circuit. A frame is made and silk is stretched over the frame. A photo resist (negative) is applied to the silk, and the screen is exposed to the negative. The screen is then developed to produce a “picture” of the circuit on the screen.

A panel is then fabricated by using a substrate that can accept the screen print inks, such as polyester, and mixing and applying conductive inks. Typically, the inks are applied in layers. After the ink is applied, the screen is cured to harden or dry the ink on the substrate.

Although the silkscreen process works to provide flexible circuitry, there are drawbacks. One drawback, generally, to silk-screening is that it uses flammable and toxic chemicals. The chemicals presently known and used for fabricating the screens are volatile and in some instances harmful. In addition, the chemical waste that is generated requires disposal. Depending upon the types of inks and/or chemicals, special handling may be required for disposal. It is also a relatively expensive process.

Moreover, there is limited flexibility (in design) using silkscreen processes. Prototyping is difficult and, once a screen is made, it cannot be easily changed, if at all.

Alternative methods for fabricating conductive circuits have used inkjet printing technologies. However, in such a technology, the ink is formulated with conductive nano-particles and then printed with a modified inkjet printer. The printed circuits are sintered (heat treated) to fully fuse the conductive particles in the ink to achieve a continuous conductive pathway to create the circuit. Drawbacks to this method are the high cost of the conductive nano-particles, the difficulty formulating a jettable ink with desired end properties, special design features that are required for the inkjet printer to handle the conductive ink and the additional sintering step required for the “printed” circuit to achieve the desired conductivity.

Accordingly, there is a need for a flexible electrically conductive circuit that is formed by a non-silkscreen process or non-inkjet process. Desirably, such a process permits flexibility in circuit design. More desirably, in such a process, the circuit is formed using a ribbon applied method. More desirably still, the process is a thermal printing process in which the circuit is readily design and created using computer-aided circuit design tools and transferred to an object using known thermal transfer processes.

### BRIEF SUMMARY OF THE INVENTION

A thermally transferable electrically conductive ribbon includes a carrier web having first and second sides and an electrically conductive layer disposed on the first side of the carrier web. A portion of the electrically conductive layer is transferable to an associated object to form an electrically conductive circuit thereon.

To facilitate release of the conductive layer from the web, a release coat is disposed on the first side of the carrier web between the carrier web and the electrically conductive layer. An adhesive layer is disposed on the electrically conductive layer to provide adhesion between the portion of the electrically conductive layer that is transferred to the associated object and the associated object.

The present ribbon and method for making and using the ribbon, avoid the time and expense of the silkscreen process. The present method forms the circuit using a ribbon applied thermal transfer process. Using the present process, an electrical circuit is readily designed, created and transferred to an object, and advantageously a flexible object such as a polyester film, using computer-aided circuit design tools and known thermal transfer or printing technologies.

These and other features and advantages of the present invention will be apparent from the following detailed description and drawings in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is a plan view of an exemplary flexible circuit formed in accordance with the principles of the present invention;

FIG. 2 is a cross-sectional view of a portion of the circuit of FIG. 1 taken along line 2-2 of FIG. 1; and

FIG. 3 is a perspective illustration of a thermally printable electrically conductive ribbon in accordance with the principles of the present invention;

FIG. 4 is a cross-sectional view of the ribbon of taken along line 4-4 of FIG. 3; and

FIG. 5 is a flow diagram illustrating one exemplary method for fabricating the flexible circuit of FIG. 1.

### DETAILED DESCRIPTION OF THE INVENTION

While the present invention is susceptible of embodiment in various forms, there is shown in the figures and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description Of The Invention”, relates to a requirement of the United States Patent Office, and does not imply, nor should be inferred to limit the subject matter disclosed herein.

The present invention permits the fabrication of flexible circuitry using thermal transfer processes. Advantageously, the present invention eliminates the need for expensive silkscreen processes, and their attendant drawbacks.

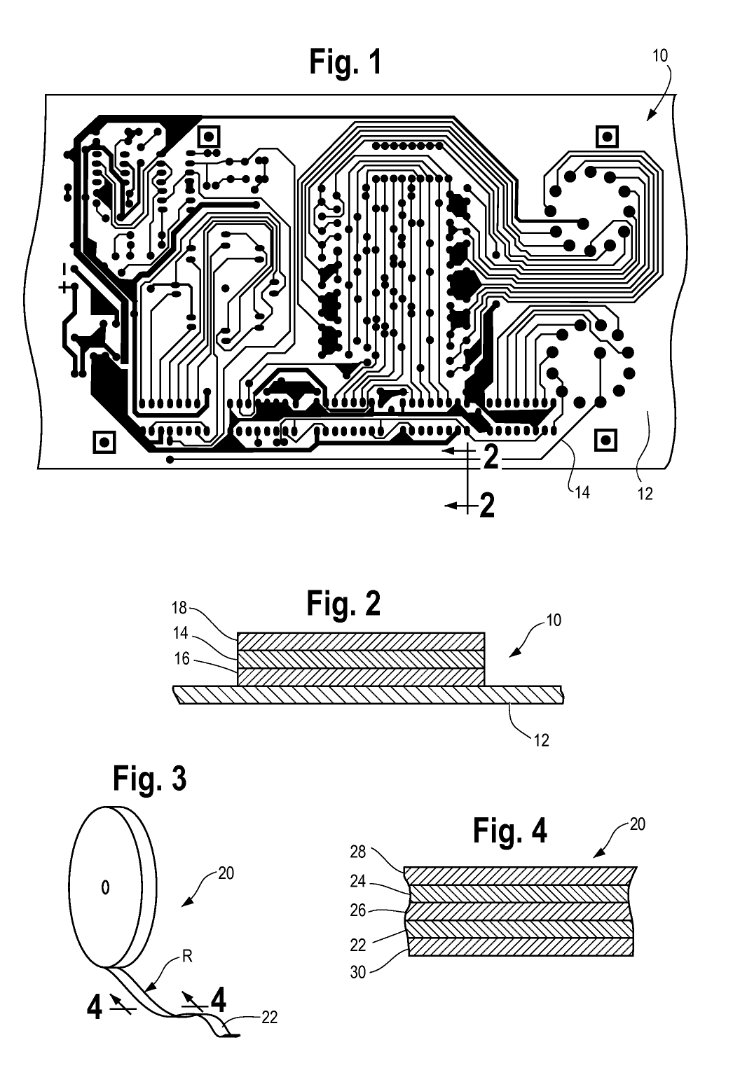

Referring to the FIG. 1, there is shown an exemplary flexible circuit 10 formed in accordance with the principles of the present invention. The circuit 10 is formed on a flexible base film or substrate 12, such as mylar, acrylic, polyester film, vinyl film, paper, paper board or most any printable substrate. It will be appreciated that the substrate need not be a flexible medium, that is, it can be a rigid medium; however, the advantages of the present invention are well appreciated in a flexible substrate 12 environment. Such flexible circuits can, for example, be used in automobile dashboards, appliance control panels, aircraft backlit panels, computers and the like.

A cross-section of the flexible circuit 10 is illustrated in FIG. 2. The substrate 12 supports and provides structure for the electrically conductive material 14. The conductive material 14 is held to the substrate 12 by an adhesive 16. An optional protective coat 18 can be applied over the conductive material 14 (layer).

A cross-section of a film 20 for use in thermally transferring the conductive material 14 (layer) to the substrate 12 is illustrated in FIG. 4. In a present form, the film 20 is formed as a ribbon R as seen in FIG. 3. Referring to FIGS. 3 and 4, the ribbon-formed film 20 includes a carrier web 22 and a release coat 24 formed on the carrier web 22. A conductive layer 26 is applied to the release coat 24 and an adhesive layer 28 is applied to the conductive layer 26. A backcoat 30 can be applied to the opposite side of the web 22 (see FIG. 3) to facilitate thermal transfer from the web 22. The backcoat 30 can be formulated to allow greater heat application (for thermal transfer) through the web 22. Those skilled in the art will recognize that as applied to the flexible circuit substrate 12, the adhesive layer 28 (forms the adhesive 16 that) adheres the electrically conductive layer 26 (to form the conductive material 14) to the substrate 12. The release coat 24 may remain on the thermal transfer film 20 (i.e. with the carrier 22) subsequent to transfer.

The carrier web 22 can be formed from any of a wide variety of materials. One known material for use in thermal printing webs 22 (carriers) is a polyester film. In commonly used thermal printing processes, a polyester film of about 4 to about 20 microns is used. The back side of the web 22 can be treated, as with the backcoat 30, to protect the film 22 as it is used in a thermal transfer process.

The release coat 24 is formulated to respond to the heat applied to the web during the thermal transfer process to “release” the subsequent layers 26, 28. One type of release coat 24 that releases with the subsequent layers 26, 28 (transfers with the conductive and adhesive layers) is an alkali-soluble thermoplastic polymer that is removed from the conductive layer (from the flexible circuit) after transfer. Removing the release coat 24 reduces the likelihood of interference with the conductive layer. The release coat 24 can be removed with an alkaline solution such as an ammonia and water mixture. Other materials that may be used that transfer with the conductive layer 26 include various waxes such as paraffin, microcrystalline or polyethylene glycol. Modifiers such as cross-linking agents or coupling agents may be added to the release layer to improve print performance.

Alternately, the release coat 24 can be of the type that remains on the web 22 and does not transfer with the subsequent layers 26, 28. These types of coatings include, for example, cross-linked silicone based materials and the like. Modifiers can be included to facilitate release of the subsequent layers 26, 28.

The electrically conductive layer 26 is applied to the web 22, over the release coat 24. The layer 26 can be formed from a wide variety of metals, such as aluminum, copper, silver, gold, platinum, molybdenum, tungsten, titanium, tantalum, germanium, silicon and silicon-containing materials, indium tin oxide (ITO), aluminum tin oxide (ATO), aluminum zinc oxide (AZO), carbon, nickel, and the like. The conductive layer 26 can be applied using processes such as spraying, coating, ion vapor deposition, vacuum metallization, sputter coating and the like. Those skilled in the art will recognize the various methods by which the conductive layer 26 can be applied to or embedded into the film. It is also contemplated that the conductive material is mixed with (e.g., formulated within) a coating such as a resin, that is applied to the web 22. In such cases the coating may be formulated to release from the carrier when printed, without the need for a release layer (such as layer 24). Optionally, the adhesive layer 28 can be applied to the substrate 12, creating a print receptive substrate, thus eliminating the need for an adhesive layer applied to the ribbon R.

The adhesive 16 (applied as layer 28) provides the necessary adhesion between the conductive material 14 and the circuit substrate 12 to assure good bonding of the conductive material 14. A preferred adhesive 16 (applied over the conductive layer 26, as adhesive layer 28) is a thermoplastic resin, such as vinyl chloride acrylic, polyester or chlorinated polyolefin resin or mixtures thereof, and is responsive (e.g., softens and fuses) at the desired transfer temperatures. Coupling agents such as silanes can be added to the adhesive layer 28 to promote adhesion of the conductive material 14 to the substrate 12.

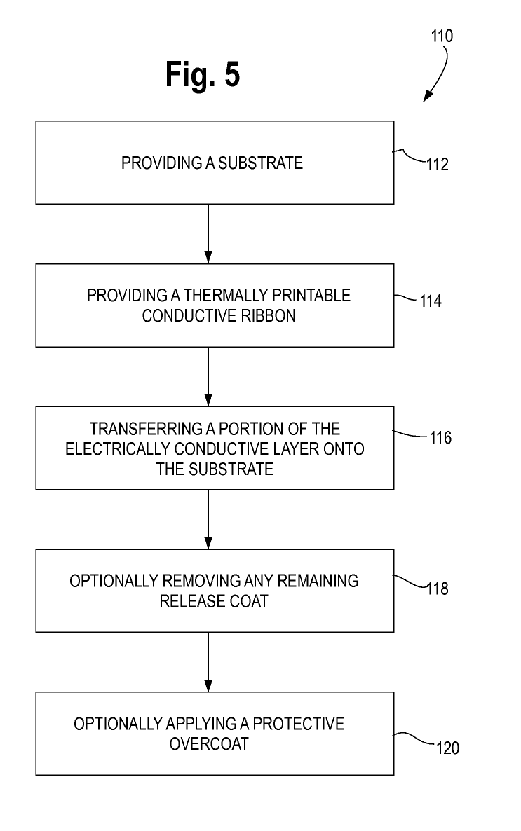

One method 110 for fabricating the flexible circuit 10 is illustrated in the flow diagram of FIG. 5. The method 110 includes the steps of providing a substrate 112, providing a thermally printable electrically conductive ribbon 114 having an electrically conductive layer thereon, and transferring a portion of the electrically conductive layer onto a flexible substrate 116. The transferred portion defines a desired electrical circuit or portion of an electrical circuit 10.

If necessary, any remaining release coat material is removed 118 from the now formed electrical circuit or portion of an electrical circuit 10. An optional protective coating (e.g., an over coating) can be applied 120 to the transferred electrical circuit 10.

One of the advantages of the present invention is that when used in conjunction with presently available circuit design tools, circuits can be designed, prototypes created and tested, in far less time and with far less effort than previously used silk-screening applications. For example, using CAD circuit design tools, a circuit can be designed, and by entering a print command, with the requisite thermally printable electrically conductive ribbon and substrate in a printer, the circuit can be printed and tested. Adjustments and/or changes can be made to a design and subsequent prototype circuits printed. Once a final design is made, production runs of the circuit can be made using the same thermal printing or transfer methods and technology.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover all such modifications as fall within the scope of the claims.

What is claimed is:

1. A thermally transferable electrically conductive ribbon comprising: a carrier web having first and second sides;
an electrically conductive layer disposed on the first side of the carrier web, wherein a portion of the electrically conductive layer is selectively transferable to an associated object to form an electrically conductive circuit thereon.

2. The thermally transferable electrically conductive ribbon in accordance with claim 1 including a release coat disposed on the first side of the carrier web between the carrier web and the electrically conductive layer.

3. The thermally transferable electrically conductive ribbon in accordance with claim 2 wherein the release coat transfers, at least in part, with the portion of the electrically conductive layer to the object.

4. The thermally transferable electrically conductive ribbon in accordance with claim 2 wherein the release coat remains with the carrier web following transfer of the portion of the electrically conductive layer to the object.

5. The thermally transferable electrically conductive ribbon in accordance with claim 1 including an adhesive layer disposed on the electrically conductive layer to provide adhesion between the portion of the electrically conductive layer that is transferred to the associated object and the associated object.

6. The thermally transferable electrically conductive ribbon in accordance with claim 1 wherein the electrically conductive layer is formed from one or more of aluminum, copper, silver, gold, platinum, molybdenum, tungsten, titanium, tantalum, germanium, silicon and silicon-containing materials, indium tin oxide (ITO), aluminum tin oxide (ATO), aluminum zinc oxide (AZO), carbon and nickel.

7. The thermally transferable electrically conductive ribbon in accordance with claim 1 wherein the carrier web is formed from a polymeric material.

8. The thermally transferable electrically conductive ribbon in accordance with claim 7 wherein the carrier web polymeric material is polyester.

9. A method for making a thermally transferable electrically conductive ribbon comprising the steps of:
providing a carrier web having a release coat on a surface thereof;
applying an electrically conductive layer on the release coat; and
applying an adhesive layer on the electrically conductive layer,
wherein a portion of the electrically layer and the adhesive layer overlying the electrically conductive layer are thermally transferable onto an associated to form an electrically conductive circuit thereon.

10. The method for making a ribbon in accordance with claim 9 including the step of applying the electrically conductive layer by vacuum metallization.

11. The method for making a ribbon in accordance with claim 9 including the step of applying the electrically conductive layer by ion vapor deposition.

12. The method for making a ribbon in accordance with claim 9 including the step of applying the electrically conductive layer by sputter coating.

13. The method for making a ribbon in accordance with claim 9 wherein the electrically conductive layer is formed from one or more of aluminum, copper, silver, gold, platinum, molybdenum, tungsten, titanium, tantalum, germanium, silicon and silicon-containing materials, indium tin oxide (ITO), aluminum tin oxide (ATO), aluminum zinc oxide (AZO), carbon and nickel.

14. A method for making an electrical circuit on a flexible substrate comprising the steps of:
providing a thermally transferable electrically conductive ribbon having a carrier web having first and second sides, a release coat disposed on the first side of the carrier web, an electrically conductive layer disposed on the release coat and an adhesive layer disposed on the electrically conductive layer;
providing a flexible substrate;
contacting the conductive ribbon, at the adhesive layer with the flexible substrate; and thermally transferring a selected portion of the electrically conductive layer and the adhesive layer overlying the selected portion to the flexible substrate and releasing the selected portion from the carrier web.

15. The method in accordance with claim 14 including the step of separating the carrier web from the flexible substrate.

16. The method in accordance with claim 14 including the step removing any release coat from the selected portion after it is transferred to the flexible substrate.
